(19) United States
(12) Patent Application Publication
(10) Pub. No.: US 2002/0053454 A1
(43) Pub. Date: May 9, 2002

(54) Position reinforcing device for ensuring proper positioning of interface cards in a computer housing

(75) Inventor: Chun-Liang Li, Tainan City (TW)

Correspondence Address: WEBB ZIESENHEIM LOGSDON ORKIN & HANSON P.C., 700 Koppers Building, 436 Seventh Avenue, Pittsburgh, PA, 15219-1818, US

(73) Assignee: COMPUCASE ENTERPRISE CO., LTD.

(21) Appl. No.: 09/962,878

(22) Filed: Sep. 25, 2001

(30) Foreign Application Priority Data
Jun. 12, 2000 (TW) 089209998

(51) Int. Cl. H02G 3/08

(52) U.S. Cl. 174/52.1

(57) ABSTRACT

A position reinforcing device includes multiple positioning units mounted on a main frame body that is disposed in a computer housing and that is formed with multiple parallel operating slots. Each positioning unit includes a block mounting seat formed with a block-receiving groove that is registered with the respective operating slot, a coupling block movably disposed in the block-receiving groove, a positioning rod coupled pivotally to the coupling block, a supporting rod interconnecting pivotally the block mounting seat and the positioning rod, and an operating member mounted movably in the respective operating slot and connected to the coupling block. The operating member is operable so as to bring an abutting portion of the positioning rod to abut against an interface card in the computer housing.

### BACKGROUND OF THE INVENTION

1. Field of the Invention

The invention relates to a position reinforcing device, more particularly to a position reinforcing device for ensuring proper positioning of interface cards in a computer housing.

2. Description of the Related Art

FIG. 1 illustrates a conventional position reinforcing device for positioning a plurality of interface cards 12 in a computer housing 1. The conventional position reinforcing device includes a main plate 11 mounted in the computer housing 1 and formed with a plurality of threaded holes 13, and a plurality of L-shaped positioning pieces 10 mounted movably on the main plate 11. Each of the positioning pieces 10 has a mounting portion 14 formed with an operating slot 15 that is registered with a respective one of the threaded holes 13, and an abutting portion 16. A screw 17 extends through the operating slot 15 in the mounting portion 14 of each of the positioning pieces 10 and the respective one of the threaded holes 13 such that the mounting portion 14 is mounted movably on the main plate 11. The mounting portion 14 is adjustable such that the abutting portion 16 can abut against a top edge of a respective one of the interface cards 12. However, because increased costs are incurred, the positioning pieces 10 must be replaced to correspond with the sizes of the interface cards 12.

FIG. 2 illustrates another conventional position reinforcing device 2 for positioning a plurality of interface cards 22 in a computer housing (not shown). The conventional position reinforcing device 2 includes a main plate 21 formed with a plurality of operating slots 23 (only one is shown), each of which is registered with a respective one of the interface cards 22 (only one is shown), and a plurality of abutting units 24 (only one is shown), each of which is mounted on the main plate 21 at a respective one of the operating slots 23. Each of the abutting units 24 includes a block mounting seat 25, an abutting rod 26, a positioning block 27, and a bolt 28. The block mounting seat 25 is retained on the main plate 21, and is formed with a block-receiving groove 251 that is registered with the respective one of the operating slots 23. The positioning block 27 is disposed in the block-receiving groove 251. The bolt 28 extends through the respective one of the operating slots 23 and is connected to the positioning block 27. The abutting rod 26 has a pivot portion connected pivotally to the block mounting seat 25 by means of a pivot pin 262 extending through the pivot portion and the block mounting seat 25, and an abutting portion 261 opposite to the pivot portion. A coiled spring 29 is sleeved on the pivot pin 262, and has opposite ends that engage the pivot portion and the block mounting seat 25, respectively. The bolt 28 is operable so as to dispose the positioning block 27 to abut appropriately against the abutting rod 26 such that the abutting portion 261 can abut against the respective one of the interface cards 22.

According to the aforesaid construction of the conventional position reinforcing device 2, the positioning block 27 acts as the point of application, the pivot portion of the abutting rod 26 acts as the fulcrum, and the abutting portion 261 acts as the point of resistance. Since the point of application is located between the fulcrum and the point of resistance, the bolt 28 is inconvenient to operate during use. Further, since the distance between the fulcrum and the point of resistance is larger than that between the fulcrum and the point of application, the abutting rod 26 is easily deformed. When the bolt 28 is loosened, due to the biasing force from the coiled spring 29, the positioning block 27 is liable to be moved away from a current positioning position, thereby resulting in poor positioning of the interface card 22.

### SUMMARY OF THE INVENTION

Therefore, the object of the present invention is to provide a position reinforcing device that can ensure proper positioning of interface cards in a computer housing.

According to the present invention, a position reinforcing device is adapted for ensuring proper positioning of a plurality of interface cards in a computer housing. The position reinforcing device comprises:

a main frame body adapted to be mounted in the computer housing and including a front plate formed with a plurality of parallel operating slots that extend along a longitudinal direction, the front plate having opposite lateral ends, and opposite first and second surfaces; and

a plurality of positioning units mounted on the main frame body, each of which includes

a block mounting seat mounted on the second surface of the front plate and having opposite front and rear open ends respectively proximate and distal to the front plate, opposite top and bottom walls and opposite lateral walls, the top and bottom walls cooperating with the lateral walls so as to define a block-receiving groove extending along the longitudinal direction and registered with a respective one of the operating slots,

a coupling block movably disposed in the block-receiving groove and having opposite front and rear end portions respectively proximate and distal to the front plate,

a positioning rod having a coupling portion coupled pivotally to the rear end portion of the coupling block, an abutting portion opposite to the coupling portion, and an intermediate portion interconnecting the coupling portion and the abutting portion,

a supporting rod having opposite pivot end portions, one of the pivot end portions being coupled pivotally to the block mounting seat adjacent to one of the lateral walls, the other of the pivot end portions being coupled pivotally to the intermediate portion of the positioning rod, and

an operating member mounted movably in the respective one of the operating slots in the front plate and having an operating end portion disposed on the first surface of the front plate, and a coupling end portion opposite to the operating end portion and connected to the front end portion of the coupling block, the operating member being operable so as to dispose the positioning rod in a selected one of an abutting position, where the abutting portion of the positioning rod is adapted to abut against a respective one of the interface cards, and a releasing position, where the abutting portion of the positioning rod is spaced apart from the respective one of the interface cards.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional position reinforcing device for ensuring proper positioning of interface cards in a computer housing;

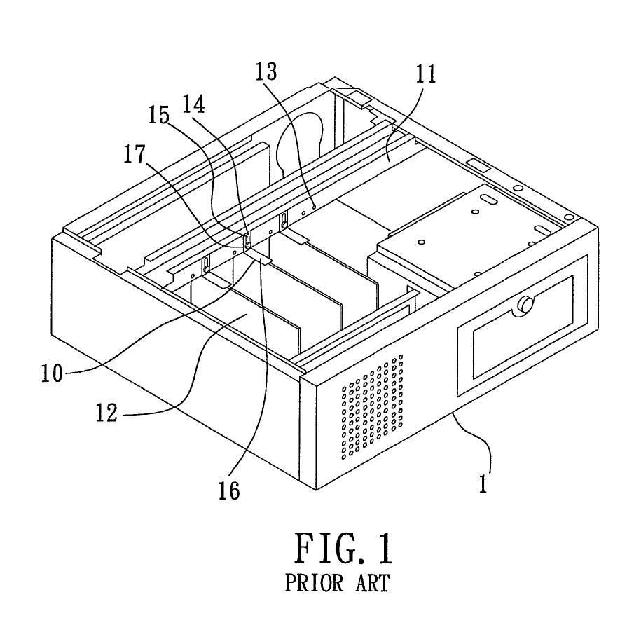

FIG. 2 is a top schematic partly sectional view of another conventional position reinforcing device for ensuring proper positioning of interface cards in a computer housing;

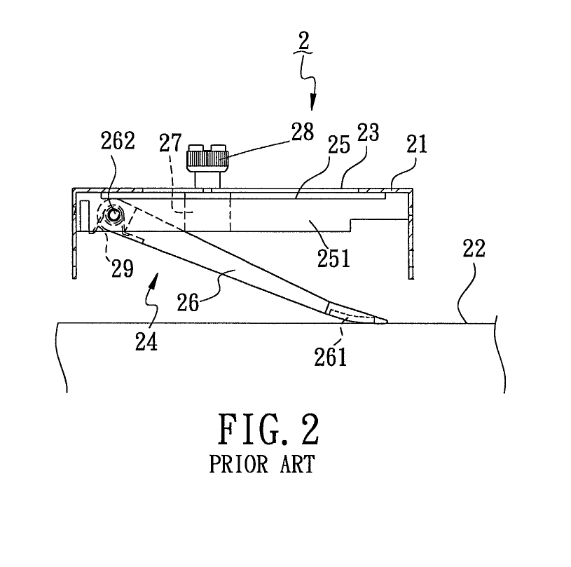

FIG. 3 is a perspective partly cutaway view showing the preferred embodiment of a position reinforcing device for ensuring proper positioning of interface cards in a computer housing according to this invention;

FIG. 4 is an exploded perspective view showing the preferred embodiment;

FIG. 5 is a top schematic partly sectional view showing a positioning rod of the preferred embodiment in a releasing position; and

FIG. 6 is a top schematic partly sectional view showing the positioning rod of the preferred embodiment in an abutting position.

### DETAILED DESCRIPTION OF THE PREFERRED EMBODIMENT

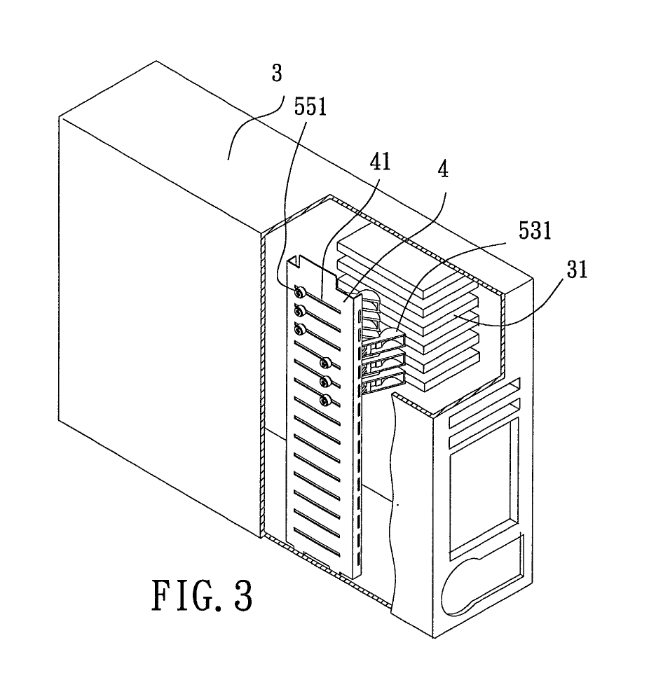

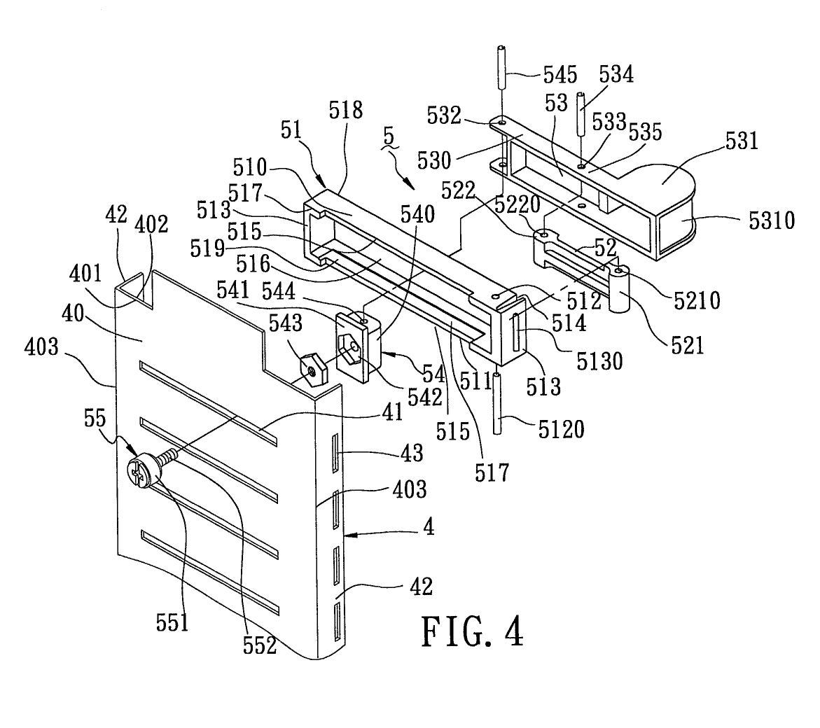

Referring to FIGS. 3 and 4, according to the preferred embodiment of this invention, a position reinforcing device is adapted for ensuring proper positioning of interface cards 31 in a computer housing 3, and is shown to include a main frame body 4, and a plurality of positioning units 5 mounted on the main frame body 4.

As shown in FIG. 4, the main frame body 4 is adapted to be mounted in the computer housing 3 and includes a front plate 40 formed with a plurality of parallel operating slots 41 that extend along a longitudinal direction. The front plate 41 has opposite lateral ends 403, and opposite first and second surfaces 401, 402. The main frame body 4 further includes opposite lateral plates 42 extending rearwardly and respectively from the lateral ends 403 of the front plate 40. Each of the lateral plates 42 is formed with a plurality of engaging slots 43.

Each of the positioning units 5 includes a block mounting seat 51, a coupling block 54, a positioning rod 53, a supporting rod 52, and an operating member 55.

The block mounting seat 51 is mounted on the second surface 402 of the front plate 40, and engages and is confined between the lateral plates 42. The block mounting seat 51 has opposite front and rear ends 517, 518 respectively proximate and distal to the front plate 40, opposite top and bottom walls 510, 511, and opposite lateral walls 513. The top and bottom walls 510, 511 cooperate with the lateral walls 513 so as to define a block-receiving groove 516 extending along the longitudinal direction and registered with a respective one of the operating slots 41. Each of the lateral walls 513 is formed with an outwardly projecting engaging rib 5130 that engages a respective one of the engaging slots 43 in the lateral plates 42 of the main frame body 4. One of the lateral walls 513 is formed with a buffer groove 514 that extends from the top wall 510 through the bottom wall 511 to permit releasable engagement between the block mounting seat 51 and the lateral plates 42 of the main frame body 514. Each of the top and bottom walls 510, 511 is formed with a notch 515 adjacent to the front open end 517 and extending along the longitudinal direction, and has an inner surface formed with a recess 519 that confronts the block-receiving groove 516 and that extends along the longitudinal direction.

The coupling block 54 is movably disposed in the block-receiving groove 516, and has opposite front and rear end portions 541, 540 respectively proximate and distal to the front plate 40 of the main frame body 4. The front end portion 541 extends into the notches 515 and is in sliding engagement with the top and bottom walls 510, 511 of the block mounting seat 51. The rear end portion 540 extends into the recesses 519 and is in sliding engagement with the top and bottom walls 510, 511 of the block mounting seat 51. The front end portion 541 is formed with a nut-receiving recess 542. The coupling block 54 further has a nut 543 retained in the nut-receiving recess 542.

The positioning rod 53 has a coupling portion 530 coupled pivotally to the rear end portion 540 of the coupling block 54 by means of a pivot pin 545 that extends through a pivot hole 544 formed in the rear end portion 540 of the coupling block 54 and a pair of holes 532 formed in the coupling portion 530, an abutting portion 531 opposite to the coupling portion 530, and an intermediate portion 535 interconnecting the coupling portion 530 and the abutting portion 531. The abutting portion 531 is preferably provided with a foam contact layer 5310 thereon.

The supporting rod 52 has opposite pivot end portions 521, 522. The pivot end portion 521 is coupled pivotally to the block mounting seat 51 adjacent to one of the lateral walls 513 by means of a pivot pin 5120 that extends through a pair of pivot holes 512 formed in the block mounting seat 51 and a pivot hole 5210 formed in the pivot end portion 521. The pivot end portion 522 is coupled pivotally to the intermediate portion 535 of the positioning rod 53 by means of a pivot pin 534 that extends through a pair of pivot holes 533 formed in the intermediate portion 535 of the positioning rod 53 and a pivot hole 5220 formed in the pivot end portion 522.

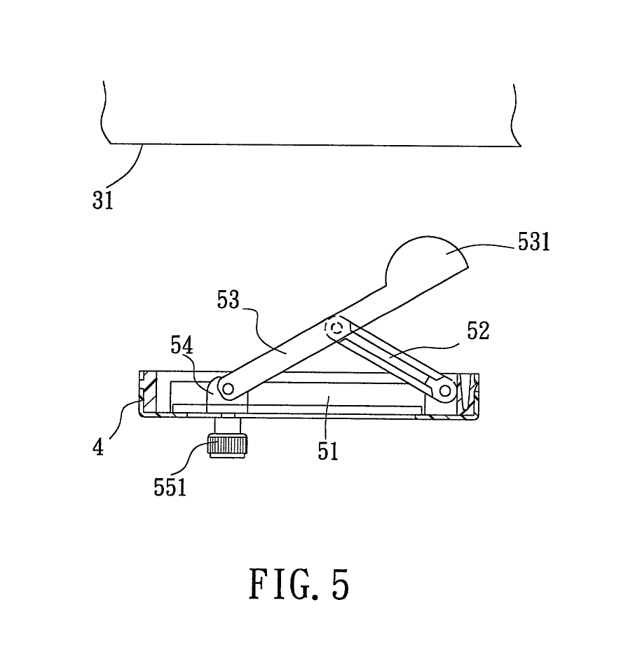

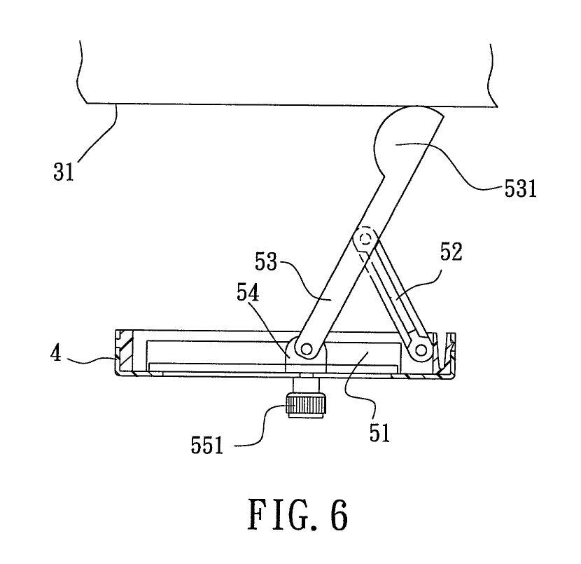

The operating member 55 is mounted movably in the respective one of the operating slots 41 in the front plate 40, and has an operating end portion disposed on the first surface 401 of the front plate 40, and a coupling end portion opposite to the operating end portion and connected to the front end portion 541 of the coupling block 54. In this embodiment, the operating member 55 is in the form of a bolt that has a head part 551 serving as the operating end portion, and a threaded shank part 552 serving as the coupling end portion. The threaded shank part 552 is in threaded engagement with the nut 543. The bolt 55 is operable so as to dispose the positioning rod 53 in a selected one of an abutting position, where the abutting portion 531 of the positioning rod 53 is adapted to abut against a respective one of the interface cards 31, as shown in FIG. 6, and a releasing position, where the abutting portion 531 of the positioning rod 53 is spaced apart from the respective one of the interface cards 31, as shown in FIG. 5.

In the present invention, the coupling block 54 acts as the point of application, the intermediate portion 535 of the positioning rod 53 acts as the fulcrum, and the abutting portion 531 acts as the point of resistance. Since the fulcrum is located between the point of application and the point of resistance, the operating member 55 can be easily operated during use so as to ensure proper positioning of the interface card 31.

It is noted that, due to the presence of the supporting rod 52, the resistance applied to the positioning rod 53 by the interface card 31 can be distributed when the positioning rod 53 is at the abutting position so that the positioning rod 53 is not easily to be deformed.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A position reinforcing device for ensuring proper positioning of a plurality of interface cards in a computer housing, said position reinforcing device comprising:
a main frame body adapted to be mounted in the computer housing and including a front plate formed with a plurality of parallel operating slots that extend along a longitudinal direction, said front plate having opposite lateral ends, and opposite first and second surfaces; and
a plurality of positioning units mounted on said main frame body, each of which includes
a block mounting seat mounted on said second surface of said front plate and having opposite front and rear open ends respectively proximate and distal to said front plate, opposite top and bottom walls, and opposite lateral walls, said top and bottom walls cooperating with said lateral walls so as to define a block-receiving groove extending along the longitudinal direction and registered with a respective one of said operating slots,
a coupling block movably disposed in said block-receiving groove and having opposite front and rear end portions respectively proximate and distal to said front plate,
a positioning rod having a coupling portion coupled pivotally to said rear end portion of said coupling block, an abutting portion opposite to said coupling portion, and an intermediate portion interconnecting said coupling portion and said abutting portion,
a supporting rod having opposite pivot end portions, one of said pivot end portions being coupled pivotally to said block mounting seat adjacent to one of said lateral walls, the other of said pivot end portions being coupled pivotally to said intermediate portion of said positioning rod, and
an operating member mounted movably in the respective one of said operating slots in said front plate and having an operating end portion disposed on said first surface of said front plate, and a coupling end portion opposite to said operating end portion and connected to said front end portion of said coupling block, said operating member being operable so as to dispose said positioning rod in a selected one of an abutting position, where said abutting portion of said positioning rod is adapted to abut against a respective one of the interface cards, and a releasing position, where said abutting portion of said positioning rod is spaced apart from the respective one of the interface cards.

2. The position reinforcing device as claimed in claim 1, wherein said main frame body further includes opposite lateral plates extending rearwardly and respectively from said lateral ends of said front plate, said block mounting seat of each of said positioning units engaging and being confined between said lateral plates.

3. The position reinforcing device as claimed in claim 2, wherein each of said lateral plates is formed with a plurality of engaging slots, each of said lateral walls of said block mounting seat of each of said positioning units being formed with an outwardly projecting engaging rib that engages a respective one of said engaging slots.

4. The position reinforcing device as claimed in claim 3, wherein one of said lateral walls of said block mounting seat of each of said positioning units is formed with a buffer groove that extends from said top wall through said bottom wall to permit releasable engagement between said block mounting seat and said lateral plates.

5. The position reinforcing device as claimed in claim 1, wherein each of said top and bottom walls of said block mounting seat of each of said positioning units is formed with a notch adjacent to said front open end and extending along the longitudinal direction, said front end portion of said coupling block extending into said notches and being in sliding engagement with said top and bottom walls of said block mounting seat.

6. The position reinforcing device as claimed in claim 1, wherein each of said top and bottom walls of said block mounting seat has an inner surface confronting said block-receiving groove and formed with a recess that extends along the longitudinal direction, said rear end portion of said coupling block extending into said recesses and being in sliding engagement with said top and bottom walls of said block mounting seat.

7. The position reinforcing device as claimed in claim 1, wherein said operating member includes a bolt that has a head part serving as said operating end portion, and a threaded shank part serving as said coupling end portion.

8. The position reinforcing device as claimed in claim 7, wherein said front end portion of said coupling block is formed with a nut-receiving recess, said coupling block further having a nut retained in said nut-receiving recess, said threaded shank part being in threaded engagement with said nut.
